(19) United States
(12) Patent Application Publication
(10) Pub. No.: US 2026/0059237 A1
(43) Pub. Date: Feb. 26, 2026

(54) SOUND REPRODUCTION SYSTEM AND METHOD

(71) Applicant: HARMAN BECKER AUTOMOTIVE SYSTEMS GMBH, Karlsbad (DE)

(72) Inventor: Laurent TUPINIER, Karlsbad (DE)

(73) Assignee: HARMAN BECKER AUTOMOTIVE SYSTEMS GMBH, Karlsbad (DE)

(21) Appl. No.: 19/305,027

(22) Filed: Aug. 20, 2025

(30) Foreign Application Priority Data
Aug. 21, 2024 (EP) 24195539.2

(51) Int. Cl. H04R 3/00; H04R 1/02

(52) U.S. Cl. CPC H04R 3/00; H04R 1/025; H04R 2499/13

(57) ABSTRACT

A sound reproduction system and method include providing audio signals using a control unit and transmitting the audio signals to a vehicle amplifier disposed in a vehicle via a wired or wireless connection; amplifying the audio signals using the vehicle amplifier; reproducing sound outside the vehicle based on the audio signals amplified by the vehicle amplifier and using at least one vehicle loudspeaker, the at least one vehicle loudspeaker being attached to the vehicle outside a vehicle cabin; monitoring movements of the vehicle using a sensor or unit for measuring and evaluating the vehicle speed; and deactivating sound reproduction when and as long the vehicle is moved.

### CROSS-REFERENCE TO RELATED APPLICATIONS

This application claims priority to European Application Serial No. 24195539.2 filed Aug. 21, 2024, the disclosure of which is hereby incorporated in its entirety by reference herein.

### TECHNICAL FIELD

The disclosure relates to a sound reproduction system and method (generally referred to as a “system”).

### BACKGROUND

Listening to music outdoors, for example, on the beach, or while camping or picnicking, is particularly popular among young people. In most cases, portable playback devices with their own power supply, such as rechargeable batteries, are taken with for use. Due to the limited available power and the limited size of such portable playback devices, the acoustic quality of the sound production for the playback devices is relatively poor. In particular, spatial sound such as stereo is only possible to a very limited extent and the sound power emitted by these devices is often too weak for the intended purpose. Better sound quality from a device suitable for outdoor activities is therefore desirable

### SUMMARY

A sound reproduction system includes a vehicle comprising a cabin, a sensor or unit for measuring and evaluating the vehicle speed, at least one vehicle loudspeaker attached to the vehicle outside the cabin and configured to reproduce sound outside the vehicle, and at least one vehicle amplifier operatively coupled to the at least one vehicle loudspeaker and configured to drive the at least one vehicle loudspeaker. A control unit is operatively coupled to the at least one vehicle amplifier via a wired or wireless connection and configured to provide audio signals and to the vehicle amplifier. The reproduction of the audio signals outside the cabin is deactivated when and as long the sensor or unit for measuring and evaluating the vehicle speed detects that the vehicle is moved.

A sound reproduction method includes providing audio signals using a control unit and transmitting the audio signals to a vehicle amplifier disposed in a vehicle via a wired or wireless connection; amplifying the audio signals using the vehicle amplifier; reproducing sound outside the vehicle based on the audio signals amplified by the vehicle amplifier and using at least one vehicle loudspeaker, the at least one vehicle loudspeaker being attached to the vehicle outside a vehicle cabin; monitoring movements of the vehicle using a sensor or unit for measuring and evaluating the vehicle speed; and deactivating sound reproduction when and as long the vehicle is moved.

Other systems, methods, features and advantages will be, or will become, apparent to one with skill in the art upon examination of the following detailed description and appended figures. It is intended that all such additional systems, methods, features and advantages be included within this description, be within the scope of the invention, and be protected by the following claims.

### BRIEF DESCRIPTION OF THE DRAWINGS

The system may be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a schematic diagram illustrating loudspeaker positions of a sound reproduction system including loudspeakers of the vehicle and the nomad device.

FIG. 2 is a schematic diagram illustrating the components involved in the sound reproduction system shown in FIG. 1 and an additional mobile device, in which the control unit is disposed in the head unit of the vehicle.

FIG. 3 is a block diagram illustrating signal paths in the sound reproduction system shown in FIGS. 1 and 2.

FIG. 4 is a schematic diagram illustrating the components involved in the sound reproduction system shown in FIG. 1 and an additional mobile device, in which the control unit is disposed in the mobile device.

FIG. 5 is a block diagram illustrating signal paths in the sound reproduction system shown in FIGS. 1 and 4.

FIG. 6 is a schematic diagram illustrating one possible loudspeaker arrangement in which a user is located in front of the loudspeakers of the vehicle and the nomad device.

FIG. 7 is a schematic diagram illustrating one possible loudspeaker arrangement in which a user is located between the loudspeakers of the vehicle and the loudspeakers of the nomad device.

FIG. 8 is a flow chart illustrating a method for the reproduction of sound using loudspeakers of a vehicle and loudspeakers of a nomad device.

### DETAILED DESCRIPTION

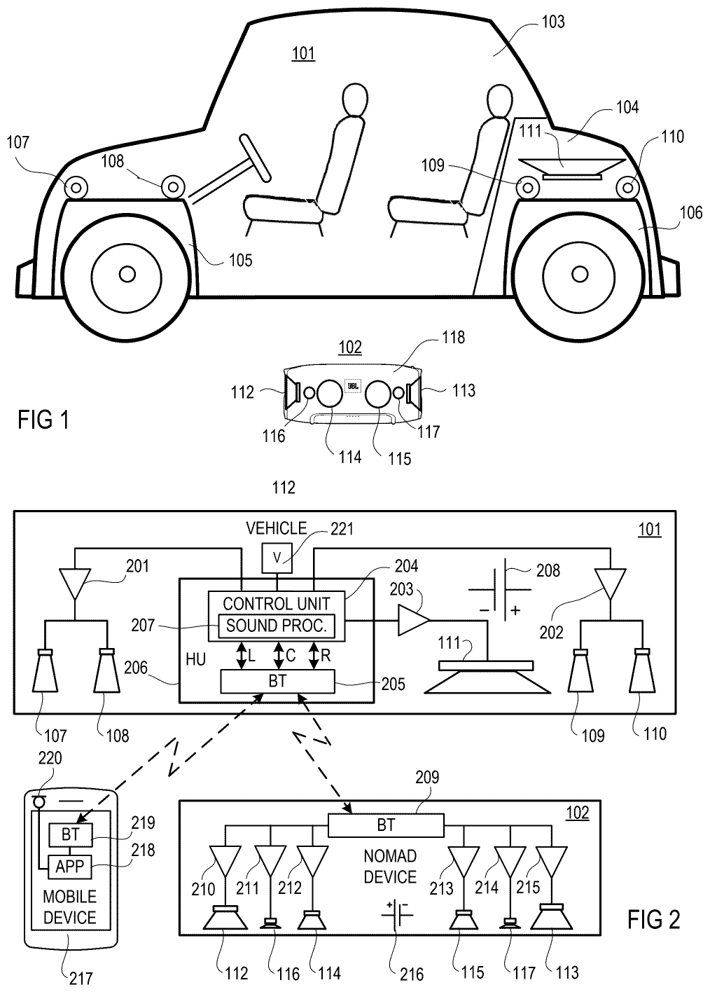

FIG. 1 illustrates loudspeaker positions of an example outdoor sound reproduction system, in which loudspeakers employed are disposed in a vehicle 101 and, optionally, additional loudspeakers may be disposed in a nomad sound reproduction device 102, e.g., a portable Bluetooth stereo speaker such as JBL's Charge 5™, Flip 6™, Boombox 3™, or Partybox™. The vehicle 101 includes, inter alia, a cabin 103, a trunk 104 and four wheelhouses, of which only the left front wheelhouse 105 and the left rear wheelhouse 106 of the vehicle 101 are shown in FIG. 1. The vehicle 101 further includes eight loudspeakers, which are disposed pairwise, for example, in the outer body around the four wheelhouses, two loudspeakers 107 and 108 of which are disposed in the left front wheelhouse 105 and two loudspeakers 109 and 110 of which are disposed, for example, in the outer body around the left rear wheelhouse 106 as shown in FIG. 1. The two other wheelhouses are identical to the wheelhouses 105 and 106, respectively, and are equipped with loudspeakers in the same way. The loudspeakers 107-110 installed in the vehicle 101 may be directed away from the car to the side and perpendicular to the longitudinal axis of the vehicle 101. Although referred to as a single loudspeaker, each loudspeaker may represent a group of loudspeakers connected in any way to each other such as connected parallel, in series or via a splitter network. The loudspeakers may be any type of speakers such as woofers, midrange loudspeakers, tweeters, broadband loudspeakers and any combination thereof and some or all of them may be part of an Acoustic Vehicle Alerting System (AVAS). The pairs of loudspeakers 107, 108 and 109, 110 as well as their counterparts around the other wheelhouses (not shown) are not necessarily identical and may be different types of loudspeakers. For example, one loudspeaker of such a pair may a pre-existing AVAS broadband loudspeaker supplemented by an added tweeter such as a horn.

The AVAS generates warning sounds designed to alert pedestrians to the presence of electric drive vehicles such as hybrid electric vehicles (HEVs), plug-in hybrid electric vehicles (PHEVs), and battery electric vehicles (BEVs) travelling at low speeds. Warning sound devices were deemed necessary by some government regulators because vehicles operating in all-electric mode produce less noise than traditional combustion engine vehicles and can make it more difficult for pedestrians and cyclists (especially those with visual impairments) to be aware of their presence. Warning sounds may be driver triggered or automatic at low speeds. In type, the warning sounds vary from clearly artificial sounds like beeps and chimes to those that mimic engine sounds and those of tires moving over gravel. The AVAS includes loudspeakers that broadcast sound into the ambience of the vehicle. As described herein, these AVAS loudspeakers or other loudspeakers installed in the outer vehicle body or a combination of both may be used for the outdoor reproduction of classical sounds such as music or speech when and only when the car is not in motion to avoid an interference with the AVAS system and to prevent a moving sound source.

Optionally, an ultra-low frequency loudspeaker, herein referred to as sub-woofer 111, may be integrated into the outdoor sound reproduction system shown in FIG. 1 and, for example, may be disposed in the trunk 104 of the vehicle 101. The sub-woofer 111 can be disposed basically anywhere in the vehicle 101 since low-frequency sound is roughly not directional and less suppressible in contrast to high-frequency sound. Consequently, other types of loudspeakers are attached to the vehicle 101 outside the cabin 103 and disposed to reproduce sound outside the vehicle 101, for example, broadcast sound into the ambience of the vehicle.

The optional nomad sound reproduction device 102 is disposed outside the vehicle 101, is freely movable and may include two low-frequency loudspeakers, herein referred to as woofers 112 and 113, two midrange-loudspeakers 114 and 115, and two high-frequency-loudspeakers, tweeters 116 and 117. These loudspeakers are mounted in, for example, a tube-shaped housing 118 in which the woofers 112 and 113 are disposed at its lateral ends and the remaining loudspeakers are disposed in the tube-shaped sidewall of the housing 118. For example, the nomad sound reproduction device 102 may be disposed in front of a side door (not shown) of the vehicle and between the two groups of loudspeakers or tweeters 107, 108 and 109, 110 disposed in the wheel housings 105 and 106. The two midrange-loudspeakers 114 and 115, and two tweeters 116 and 117 are directed in the same direction as the tweeters 107-110. The woofers 112 and 113 are directed in opposite directions parallel to the longitudinal axis of the vehicle 101. Although a system with only one nomad device is shown and explained herein, one or more additional nomad devices can be integrated into the system.

FIG. 2 is a block diagram illustrating components involved in an example sound reproduction system using the loudspeaker configuration shown in FIG. 1. The tweeters 107-110 and the optional sub-woofer 111 mounted to the vehicle 101 are supplied via amplifiers 201-203 with sound signals provided by a control unit 204. The control unit 204 is operatively coupled to the amplifiers 201-203 by wire. A vehicle communication interface, such as a Bluetooth (BT) interface 205 (or any other wireless communication interface such as WiFi), is operatively coupled to the control unit 204 and transmits wirelessly audio signals L, R to be reproduced and control signals C using the BT interface 205. In the example system shown in FIG. 2, the control unit 204 and the BT interface 205 are disposed in the vehicle and may be part of a head unit (HU) 206 thereof as shown or an Electronic Control Unit (ECU) thereof which is not shown. The control unit 204 may include a sound processor 207 that allows for general sound control such as volume control and equalization but may also transform stereo audio signals into higher order surround sound as described below. The head unit 206 and its components are supplied with power by a vehicle battery 208. The loudspeakers 107 and 108 in combination with amplifier 201, the loudspeakers 109 and 110 in combination with amplifier 202, and sub-woofer 111 in combination with amplifier 203 form each a specific audio signal channel of the vehicle 101. The control unit 204 may deactivate the sound reproduction of the sound reproduction system when and as long the vehicle 101 is moved as detected by a sensor or unit for measuring and evaluating the vehicle speed 221. Although a head unit is shown and explained, a central computer or other suitable data processing structures may be used additionally or alternatively.

The nomad sound reproduction device 102 includes the six loudspeakers 112-117, a nomad communication interface, such as the BT interface 209 (or a WiFi interface etc.), and six amplifiers 210-215 operatively coupled to the BT interface 209 and the six loudspeakers 112-117. The amplifiers 210-215 each drive one of the loudspeakers 112-117 based on the audio signals received by the BT interface 209 from the BT interface 205 in the vehicle 101. Loudspeakers 112, 114, 116 in connection with amplifiers 210-212 form one audio signal channel, while loudspeakers 113, 115, 117 in connection with amplifiers 213-215 form another audio signal channel of the nomad sound reproduction device 102. The nomad sound reproduction device 102 and its components are supplied with power by, for example, a rechargeable battery 216 which may be connected to the vehicle battery 208 for charging or during operation of the nomad sound reproduction device 102 together with the vehicle 101.

Optionally, a mobile device 217 such as a smartphone with an installed dedicated software application (APP) 218 may be integrated into the audio reproduction system. The mobile device 217 further includes a mobile communication interface, such as the BT interface 219 (or a WiFi interface etc.) and a microphone 220. The BT interface 219 allows for wireless communication with the vehicle communication interface, i.e., the BT interface 205, in order to send at least one of control signals, including instructions and audio signals, to the BT interface 205. The dedicated software application 218 installed on the mobile device 217 allows controlling the mobile device 217 and, via the mobile device 217, the control unit 204 of the vehicle 101. The microphone 220 may be used by the software application 218 to adjust, for example, calibrate the sound of the sound reproduction system. The software application 218 may continuously adjust the sound so that the sound experienced by a listener that walks around is kept constant.

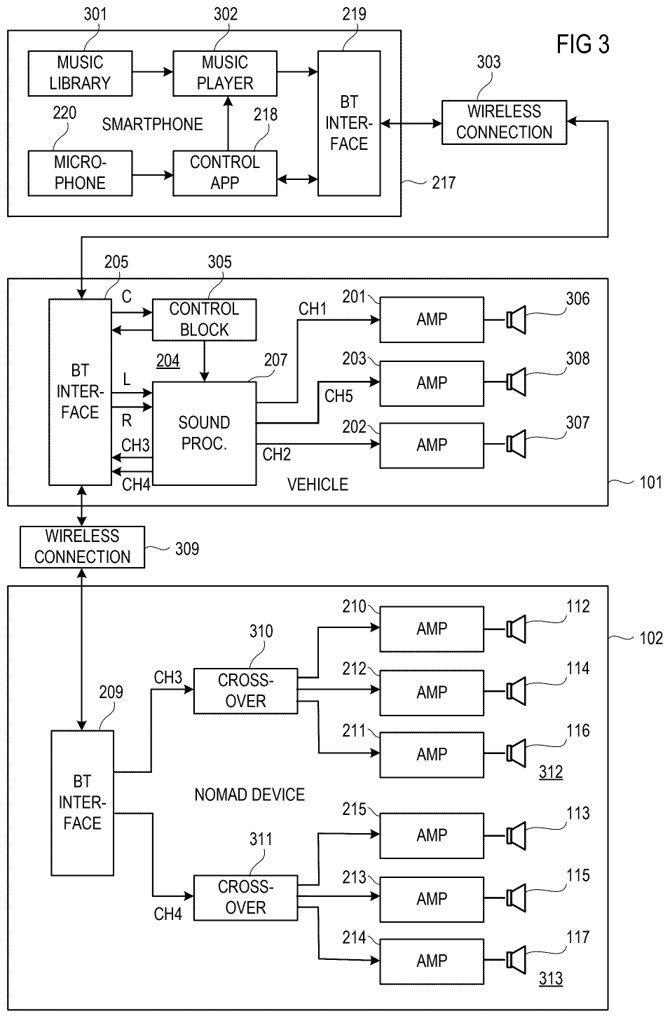

FIG. 3 illustrates signal paths in the example sound reproduction system shown in FIGS. 1 and 2. For example, the mobile device 217 may include a music library 301 and a preinstalled music player 302 and provide to the BT interface 219 of the mobile device 217 stereo audio signals to be reproduced. The software application 218 allows control of the music player 302 that allows the execution of user instructions such as play, stop, back, forth, jump and select from a list. Alternatively or additionally, another music player and music library (both not shown) may be implemented in the vehicle 101, for example, in the control block 305 of the head unit 206 of the vehicle 101. The other music player and music library may be controllable by the software application 218 or may be standalone, i.e., controllable via the head unit or other elements in the vehicle 101.

The software application 218 further allows controlling the sound processor 207 by the control signal C and via the BT interface 219, the (bi-directional) wireless connection 303 (e.g., BT connection), the BT interface 205, and a control block 305 of the control unit 204. Control of the sound processor 207 includes, for example, volume control, equalization adjustment, and sound reproduction mode selection. The sound processor 207 generates the audio signals for the groups of loudspeakers 306-308 in the vehicle. For example, group 306 includes loudspeakers 107 and 108, group 307 includes loudspeakers 109 and 110, and optional group 308 includes only sub-woofer 111. Accordingly, the audio signals for groups 306 and 307 may be broad-band audio signals, and the audio signal for group 308 may be an ultra-low-frequency audio signal. The audio signals provided by the audio processor 207 are based on a stereo audio signal received from the mobile device 217 and are amplified per group 306-308 of loudspeakers using amplifiers 201, 202, and 203 (optional).

The BT interface 205 wirelessly (and bi-directionally) communicates not only with the BT interface 219 of the mobile device 217 but also with the BT interface 209 of the nomad device 102 using a (bi-directional) wireless BT that the loudspeaker frequency ranges match with the frequency ranges of the audio signal components supplied to them, respectively.

The sound equalization may be adjusted manually or automatically involving the software application 218 and the sound processor 207. For automatic sound equalization the software application 218 may use the microphone 220 to pick up a test sound reproduced by one or more of the loudspeakers 107-111, and 112-117. For example, all loudspeakers 107-111, and 112-117 are sequentially supplied with the test sound (or the desired content currently played), which may be a broadband white noise (or any other suitable test tone such as a wobbling sine tone or a pattern of sine or noise tones). The equalization is then adjusted to meet a target frequency characteristic that may be selected by a user through a user interface of the software application 218. The sound volume may be adjusted manually or automatically. The sound equalization may be done continuously (including a periodically repeated equalization) process based, for example, on the audio signals to be reproduced, to allow a listener wearing the mobile device 217 to experience a constant sound at various positions.

The sound processor 207 may be operated in various sound modes including mono, stereo and some surround sound modes. In the example signal flowchart shown in FIG. 3, the sound processor 207 receives the two channels L and R of the stereo signal to be reproduced and generates a four channel audio signal (channels CH1-CH4) if no sub-woofer is used, and a five channel audio signal (channels CH1-CH5) if a sub-woofer such as sub-woofer 111 of group 308 is used. Channels CH1, CH2 and CH5 (if available) are reproduced using the loudspeakers 107-111 of groups 306-307 disposed in the vehicle 101. Channels CH3 and CH4 are transmitted to the nomad device 102 where they are reproduced via loudspeakers or woofers 112, 114 and 116, which form a group 312 of loudspeakers that reproduces channel CH3, and loudspeakers 113, 115 and 117, which form a group 313 of loudspeakers that reproduces channel CH4.

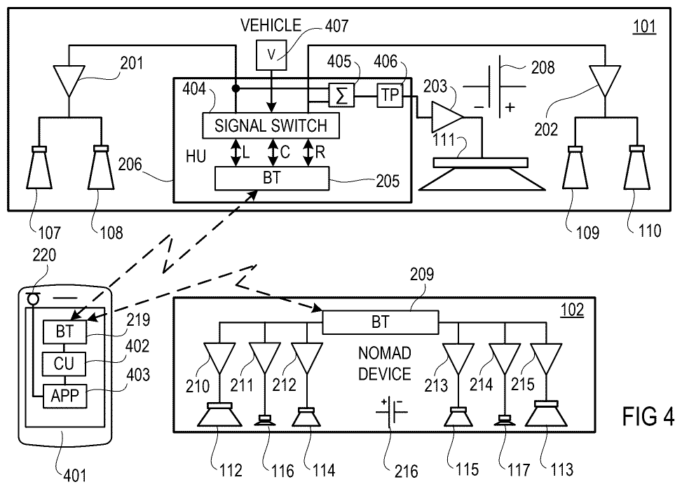

FIG. 4 shows the components involved in another example of a sound reproduction system using the loudspeaker configuration shown in FIG. 1 and an additional mobile device 401, in which the control unit, here control unit 402, is disposed in the mobile device 401 with an alternative software application 403 installed (shown) or operated in another mode of software application 218 (not shown). BT (or WiFi etc.) connections are established between the mobile device 401 and the vehicle 101 and between the mobile device 401 and the nomad sound reproduction device 102. The nomad device 102 is identical to the one shown in FIGS. 2 and 3. In this example, the vehicle 101 is configured so that the head unit 206 does not provide the essential audio signal processing as shown in and described in connection with FIGS. 2 and 3 as the audio processing takes place in the mobile device 401. Instead, the head unit 206 receives and decodes Bluetooth signals from the mobile device 401 using BT interface 205 in order to provide audio signals L, R and control signals C, which are supplied to a signal switching arrangement 404 that can switch the audio signals L and R on and off dependent on the control signal C and a signal from the sensor or unit for measuring and evaluating the vehicle speed 407 before signals L and R are supplied to amplifiers 201 and 202, respectively. amplifier 203 receives a low-pass filtered sum signal of the audio signals L and R using a summer 405 and a low-pass filter 406. The signal switching arrangement 404 in connection with a sensor or unit for measuring and evaluating the vehicle speed 407 deactivates audio signal reproduction when and as long the vehicle 101 is moved. The sensor or unit for measuring and evaluating the vehicle speed 407 (211) may be a preexisting device of the vehicle such as a wheel speed sensor (WSS) or vehicle speed sensor (VSS) or any other type of tachometer, e.g., combined with a dedicated evaluation device configured to detect a motion of the vehicle.

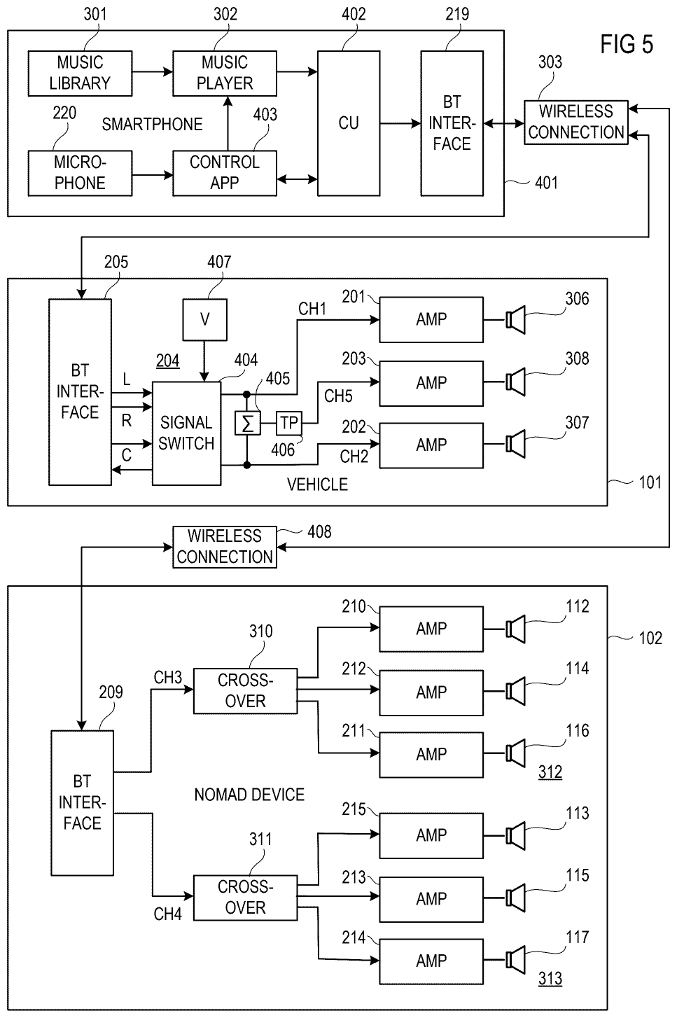

FIG. 5 illustrates the signal paths in the sound reproduction system shown in FIGS. 1 and 4. For example, the mobile device 401 may include the music library 301 and the music player 302 and provide the stereo audio signals to be reproduced via the control unit 402 to the BT interface 219 of the mobile device 217. The software application 403 allows control of the control unit 402 and the music player 302. At least one of the music library 301, music player 302, software application 403, BT interface 219, and microphone 220, may be identical to the corresponding components of the mobile device 217 shown in FIGS. 2 and 3. Although two different mobile devices are described above with respect to FIGS. 2, 3 and 4, 5, a single mobile device can be used which allows for two respective operating modes in a single software application in connection with appropriate hardware. The sound equalization may be adjusted manually or automatically in manner similar to or identical to the system shown in and described in connection with FIGS. 2 and 3, including the continuous adjustment mode.

As described above, the head unit 206 of vehicle 101 does not provide the essential audio signal processing as shown in and described in connection with FIGS. 2 and 3. The audio processing takes place in the mobile device 401 in the system shown in FIG. 5. The head unit 206 receives and decodes Bluetooth signals from the mobile device 401 using the BT interface 205 which provides the audio signals L, R and control signals C. These signals are supplied to the signal switching arrangement 404 that can switch the audio signals L and R on and off dependent on the control signal C and a signal from the sensor or unit for measuring and evaluating the vehicle speed 407. Audio signals L and R are supplied as channels CH1 and CH2 by the signal switching arrangement 404 to amplifiers 201 and 202, respectively. Channel CH5 supplied to amplifier 203 is derived from the low-pass filtered sum signal of the audio signals L and R using the summer 405 and the low-pass filter 406. The nomad device 102 receives directly from the mobile device 401 via a wireless connection 408 channels CH3 and CH4.

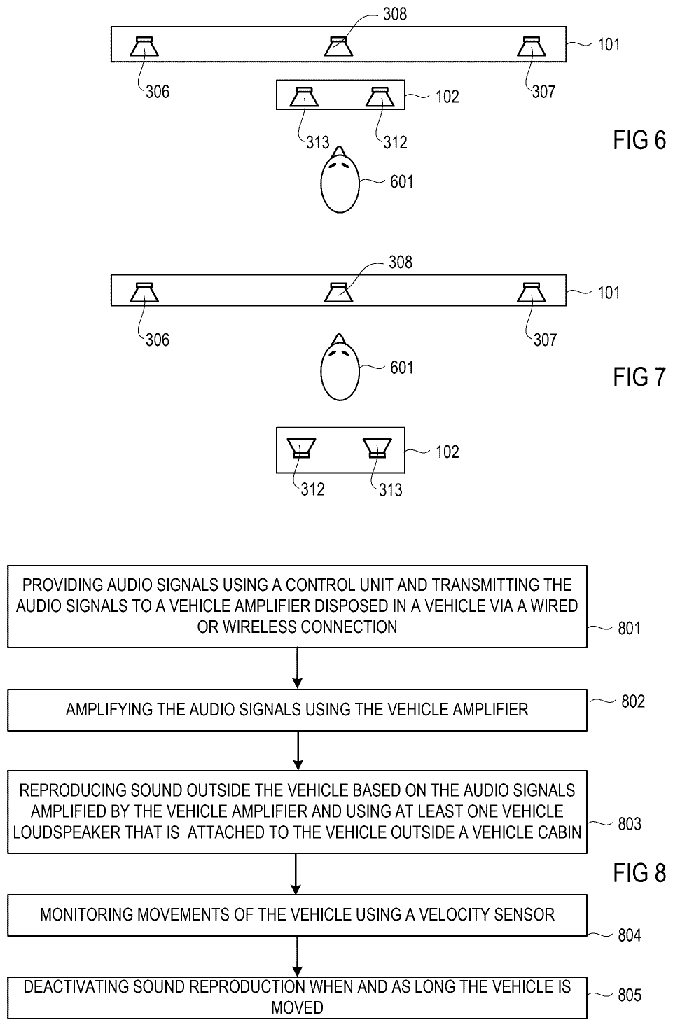

The channels CH1-CH4 (CH5) may be used in various signal configurations with different loudspeaker arrangements as depicted in FIGS. 6 and 7. Two basic loudspeaker arrangements differ from each other in that in the first arrangement shown in FIG. 6 all groups of loudspeakers 306, 307, 308 (optional), 312 and 313 are aligned with each other in the direction of a user 601 located in front of the groups of loudspeakers 306, 307, 308 (optional), 312 and 313. The user 601 looks towards the vehicle 101 and the nomad device 102. In the second arrangement shown in FIG. 7, the groups of loudspeakers 306, 307 and 308 (optional subwoofer group 308) in the vehicle 101 are aligned with each other in the opposite direction from which the groups 312 and 313 of loudspeakers in the nomad device 102 are (partly) aligned. The user 601 is located between the vehicle 101 and the nomad device 102 and is looking towards the vehicle 101 with the nomad device 102 behind him or her.

These two example arrangements allow for a multiplicity of signal configurations. Based on the arrangement shown in FIG. 6, an enhanced stereo sound can be created in that loudspeaker groups 306 and 313 are supplied with the left stereo channel L and loudspeaker groups 307 and 312 are supplied right stereo channel R. The optional subwoofer group 308 may be supplied with the low-pass filtered sum signal of the left stereo channel L and right stereo channel R. As can be seen from FIG. 6, the stereo basis of the nomad device 102 has been extended so that it may now be equal to the distance between the two loudspeaker groups 306 and 307. Alternatively, a three-channel configuration can be established. Loudspeaker group 306 is coupled to channel CH1 to form a left channel, loudspeaker group 307 is coupled to channel CH2 to form a right channel, and loudspeaker groups 312 and 313 in connection with channels CH3 and 4 are connected in parallel to form a mid-channel. The optional subwoofer group 308 may be supplied with the low-pass filtered sum signal of channels CH3 and CH4 (to set up a pseudo three channel configuration) or with a signal of an additional sub-woofer channel (to set up a three channel configuration).

Based on the arrangement shown in FIG. 7, a four-channel configuration, for example, a quadrophonic configuration, can be established in which each of channels CH1-CH4 in connection with loudspeaker groups 306, 307, 312 and 313 is used as one of the four quadrophonic channels. With the addition of the optional subwoofer group 308 in connection with the additional (sub-woofer) channel CH5 a five-channel configuration such as a 4.1 surround sound configuration can be established. In general, the arrangements shown in FIGS. 6 and 7 allow for a one-channel configuration (e.g., a monaural configuration where all loudspeaker groups are supplied with a mutual single audio signal), two-channel configurations (e.g., stereo configurations in different implementations), three-channel configurations (e.g., with two main channels and one auxiliary channel, or with three main channels), four-channel configurations (e.g., two main channels and two auxiliary channels, three main channels and one auxiliary channel, or four main channels), and five-channel configurations (e.g., four main channels and one auxiliary channel, or five main channels).

Referring to FIG. 8, an example sound reproduction method includes providing audio signals using a control unit and transmitting the audio signals to a vehicle amplifier disposed in a vehicle via a wired or wireless connection (procedure 801), amplifying the audio signals using the vehicle amplifier (802), and reproducing sound outside the vehicle based on the audio signals amplified by the vehicle amplifier and using at least one vehicle loudspeaker that is attached to the vehicle outside a vehicle cabin (procedure 803). The method further includes monitoring movements of the vehicle using a sensor or unit for measuring and evaluating the vehicle speed (procedure 804) and deactivating sound reproduction when and as long the vehicle is moved (procedure 805).

The method described above may be encoded and stored in a computer-readable medium such as a CD ROM, disk, flash memory, RAM or ROM, an electromagnetic signal, or other machine-readable medium as instructions for execution by a processor. Alternatively or additionally, any type of logic may be utilized and may be implemented as analog or digital logic using hardware, such as one or more integrated circuits (including amplifiers, adders, delays, and filters), or one or more processors executing amplification, adding, delaying, and filtering instructions; or in software in an application programming interface (API) or in a Dynamic Link Library (DLL), functions available in a shared memory or defined as local or remote procedure calls; or as a combination of hardware and software.

The method may be implemented in parts or in total by software and/or firmware stored on or in a computer-readable medium, machine-readable medium, propagated-signal medium, and/or signal-bearing medium. The media may comprise any device that contains, stores, communicates, propagates, or transports executable instructions for use by or in connection with an instruction executable system, apparatus, or device. The machine-readable medium may selectively be, but is not limited to, an electronic, magnetic, optical, electromagnetic, or infrared signal or a semiconductor system, apparatus, device, or propagation medium. A non-exhaustive list of examples of a machine-readable medium includes: a magnetic or optical disk, a volatile memory such as a Random Access Memory “RAM,” a Read-Only Memory “ROM,” an Erasable Programmable Read-Only Memory (i.e., EPROM) or Flash memory, or an optical fiber. A machine-readable medium may also include a tangible medium upon which executable instructions are printed, as the logic may be electronically stored as an image or in another format (e.g., through an optical scan), then compiled, and/or interpreted or otherwise processed. The processed medium may then be stored in a computer and/or machine memory.

The systems may include at least one of a controller, microprocessor, microcontroller, application specific integrated circuit (ASIC), discrete logic, and other types of circuits or logic, and may be implemented in many different ways. Similarly, memories may be DRAM, SRAM, Flash, or other types of memory. Parameters (e.g., conditions and thresholds) and other data structures may be separately stored and managed, may be incorporated into a single memory or database, or may be logically and physically organized in many different ways. Programs and instruction sets may be parts of a single program, separate programs, or distributed across several memories and processors.

The description of embodiments has been presented for purposes of illustration and description. Suitable modifications and variations to the embodiments may be performed in light of the above description or may be acquired from practicing the methods. For example, unless otherwise noted, one or more of the described methods may be performed by a suitable device and/or combination of devices. The described methods and associated actions may also be performed in various orders in addition to the order described in this application, in parallel, and/or simultaneously. The described systems are exemplary in nature and may include additional elements and/or omit elements.

As used in this application, an element or step recited in the singular and proceeded with the word “a” or “an” should be understood as not excluding plural of said elements or steps, unless such exclusion is stated. Furthermore, references to “one embodiment” or “one example” of the present disclosure are not intended to be interpreted as excluding the existence of additional embodiments that also incorporate the recited features. The terms “first,” “second,” and “third,” etc. are used merely as labels, and are not intended to impose numerical requirements or a particular positional order on their objects.

While various embodiments of the invention have been described, it will be apparent to those of ordinary skilled in the art that many more embodiments and implementations are possible within the scope of the invention. In particular, the skilled person will recognize the interchangeability of various features from different embodiments. Although these techniques and systems have been disclosed in the context of certain embodiments and examples, it will be understood that these techniques and systems may be extended beyond the specifically disclosed embodiments to other embodiments and/or uses and obvious modifications thereof.

What is claimed is:

1. A sound reproduction system for a vehicle including a cabin, the system comprising:
a sensor for measuring vehicle speed,
at least one vehicle loudspeaker arranged outside of the cabin of the vehicle and configured to reproduce sound outside the vehicle,
at least one vehicle amplifier operatively coupled to the at least one vehicle loudspeaker and configured to drive the at least one vehicle loudspeaker; and
a control unit operatively coupled to the at least one vehicle amplifier via a wired or wireless connection, and the control unit being configured to provide audio signals and to the vehicle amplifier; wherein the reproduction of the audio signals outside the cabin is deactivated in response to the vehicle speed indicating that the vehicle.

2. The system of claim 1, further comprising a nomad sound reproduction device arranged outside the vehicle and being freely movable, the nomad sound reproduction device comprising at least one nomad loudspeaker and at least one nomad amplifier operatively coupled to the at least one nomad loudspeaker, the at least one nomad amplifier being configured to drive the at least one nomad loudspeaker, and the at least one nomad amplifier being operatively coupled to the control unit via a wireless connection.

3. The system of claim 2, further comprising a mobile device operatively coupled to the vehicle via a wireless connection or to both the vehicle and the nomad sound reproduction device each via a wireless connection, wherein the mobile device is configured to control the control unit.

4. The system of claim 3, wherein the control unit is included in the mobile device and operatively coupled to the at least one vehicle amplifier via a wireless connection.

5. The system of claim 1, wherein the control unit is included in the vehicle and operatively coupled to the at least one vehicle amplifier via a wired connection.

6. The system of claim 3, wherein the mobile device includes a microphone, the microphone being used by the control unit to adjust the sound to be reproduced by at least one of the at least one vehicle loudspeaker and the at least one nomad loudspeaker.

7. The system of claim 6, wherein the control unit is configured to continuously adjust the sound to be reproduced by the at least one of the at least one vehicle loudspeaker and the at least one nomad loudspeaker.

8. The system of claim 2, wherein the control unit is configured to drive the at least one vehicle loudspeaker and the at least one nomad loudspeaker in a surround sound mode.

9. A sound reproduction method comprising:
providing audio signals by a control unit and transmitting the audio signals to a vehicle amplifier disposed in a vehicle via a wired or wireless connection;
amplifying the audio signals by the vehicle amplifier;
reproducing sound outside the vehicle by at least one vehicle loudspeaker based on the audio signals amplified by the vehicle amplifier, the at least one vehicle loudspeaker being arranged outside a vehicle cabin;
monitoring movements of the vehicle using a sensor for measuring vehicle speed; and
deactivating sound reproduction in response to determining that the vehicle is moving based on the sensed vehicle speed.

10. The method of claim 9, further comprising:
transmitting the audio signals to a nomad amplifier arranged in a nomad sound reproduction device via a wireless connection;
amplifying the audio signals using the nomad amplifier; and
reproducing sound based on the audio signals amplified by the nomad amplifier by at least one nomad loudspeaker arranged in the nomad sound reproduction device; wherein
the nomad sound reproduction device is arranged outside the vehicle and is freely movable.

11. The method of claim 10, further comprising controlling the control unit by a mobile device, the mobile device being operatively coupled to the vehicle via a wireless connection or to both the vehicle and the nomad sound reproduction device each via a wireless connection.

12. The method of claim 11, wherein the control unit is included in the mobile device and operatively coupled to the vehicle amplifier via a wireless connection.

13. The method of claim 9, wherein the control unit is included in the vehicle and operatively coupled to the vehicle amplifier via a wired connection.

14. The method of claim 11, further comprising adjusting the sound to be reproduced by at least one of the at least one vehicle loudspeaker and the at least one nomad loudspeaker through the control unit in connection with a microphone disposed in the mobile device.

15. The method of claim 14, further comprising continuously adjusting the sound to be reproduced by the at least one of the at least one vehicle loudspeaker and the at least one nomad loudspeaker.

16. A sound reproduction system for a vehicle including a cabin, the system comprising:
a sensor for detecting vehicle speed,
at least one vehicle loudspeaker attached to the vehicle outside of the cabin and configured to reproduce sound outside the vehicle,
at least one vehicle amplifier operatively coupled to the at least one vehicle loudspeaker and configured to drive the at least one vehicle loudspeaker; and
a control unit operatively coupled to the at least one vehicle amplifier via a wired or wireless connection, and the control unit being configured to provide audio signals and to the at least one vehicle amplifier; wherein the reproduction of the audio signals outside the cabin is deactivated in response to the sensor detecting that the vehicle is moving based on the vehicle speed.

17. The system of claim 16, further comprising a nomad sound reproduction device disposed outside the vehicle and being freely movable, the nomad sound reproduction device including at least one nomad loudspeaker and at least one nomad amplifier operatively coupled to the at least one nomad loudspeaker, the at least one nomad amplifier being configured to drive the at least one nomad loudspeaker, and the at least one nomad amplifier being operatively coupled to the control unit via a wireless connection.

18. The system of claim 17 further comprising a mobile device operatively coupled to the vehicle via a wireless connection or to both the vehicle and the nomad sound reproduction device each via a wireless connection, wherein the mobile device controls the control unit.

19. The system of claim 18, wherein the control unit is included in the mobile device and operatively coupled to the at least one vehicle amplifier via a wireless connection.

20. The system of claim 18, wherein the mobile device includes a microphone, the microphone being used by the control unit to adjust the sound to be reproduced by at least one of the at least one vehicle loudspeaker and the at least one nomad loudspeaker.
